(19) United States
(12) Patent Application Publication
(10) Pub. No.: US 2023/0359635 A1
(43) Pub. Date: Nov. 9, 2023

(54) Event Organizer System

(71) Applicant: William Paskell, London (GB)

(72) Inventor: William Paskell, London (GB)

(21) Appl. No.: 18/245,116

(22) PCT Filed: Sep. 10, 2021
(86) PCT No.: PCT/GB2021/052344

§ 371 Date: Mar. 13, 2023

(30) Foreign Application Priority Data
Sep. 11, 2020 (GB) 2014344.2

(51) Int. Cl. G06F 16/2457

(52) U.S. Cl. CPC G06F 16/24578

(57) ABSTRACT

Disclosed is a system for event organisation, event interests capture and events display. The system includes an events collection, containing events and each event having a time value and category structure, including categories and sub-categories, and a plurality of cross-category commodities, each having an interest relating to more than one category or subcategory. Using an interest selection display interface, users can rapidly and without duplication select and/or deselect, only necessary once or amending when desired interests in one or more categories or sub-categories at various levels of specificity, and/or interests in one or more cross-category commodities applicable to given categories or sub-categories, and/or interests in one or more cross-category commodities applicable irrespective of categories or combinations thereof.

### BACKGROUND

### 1.1 Introduction

The present specification relates to an event organiser system, particularly an electronic event organiser that allows users to search and/or be notified of events.

The internet is widely used to search for events that might be of interest to a user, based both on the kind of event and the location of the event. Further electronic calendars are also widely employed that allow a user to note when an event is, so that a user can keep track of events in the future. However many drawbacks and challenges remain in seeking events for one's interests, necessarily repeated over time as new events arise.

### SUMMARY

The object of the present invention is to provide a system that removes these difficulties and allows users to more easily specify their interests and become aware of and act on events of interest to them, efficiently at any time they need.

According to the present invention, there is provided a system according to claim 1.

### BRIEF DESCRIPTION OF THE DRAWINGS

### 1.2 Introduction—Figures

The invention will now be described, by way of example, with reference to the drawings, of which:

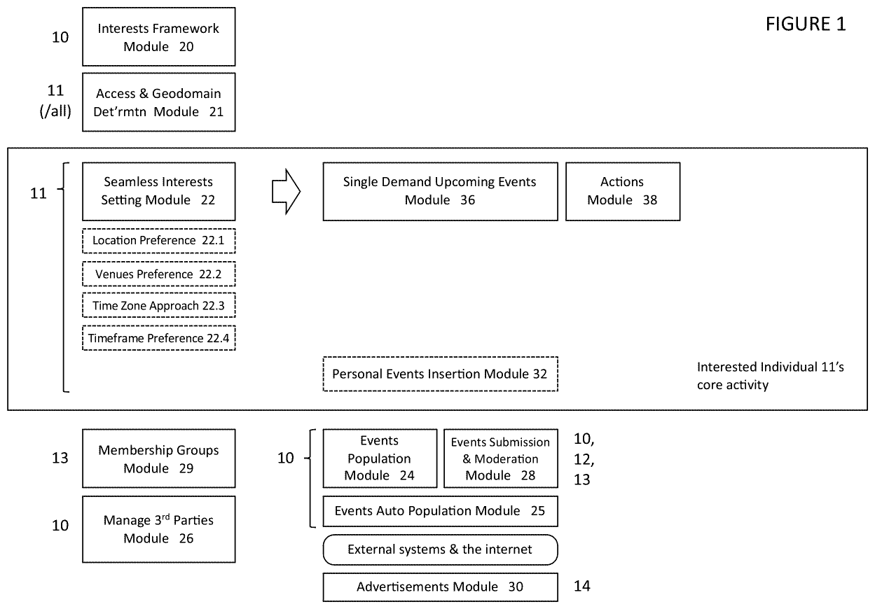

FIG. 1 is a diagrammatic representation of the modular architecture of the system;

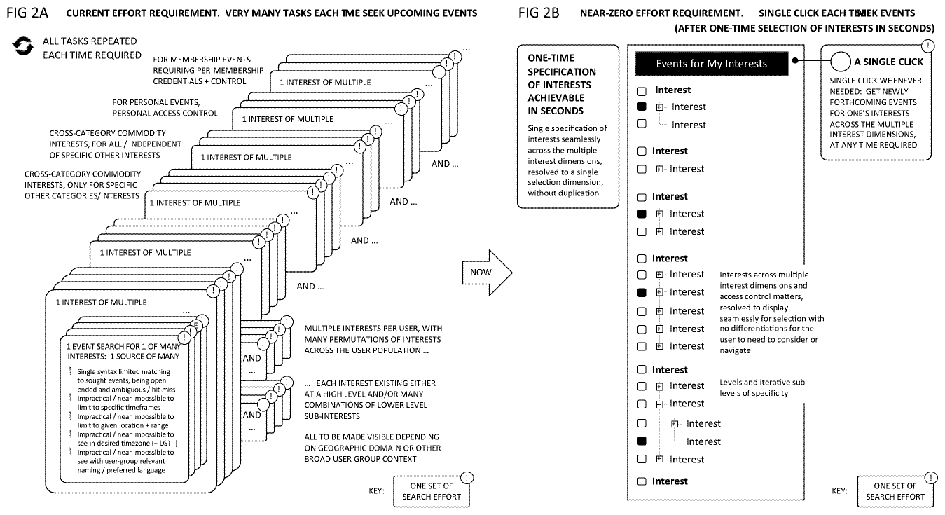

FIG. 2A is a diagrammatic representation of the current effort requirements in establishing a consolidated set of upcoming events for one's interests, associated with the prior art

FIG. 2B is a diagrammatic representation of the greatly reduced effort required to seek events and initial interests specification associated with the current embodiment/the present invention

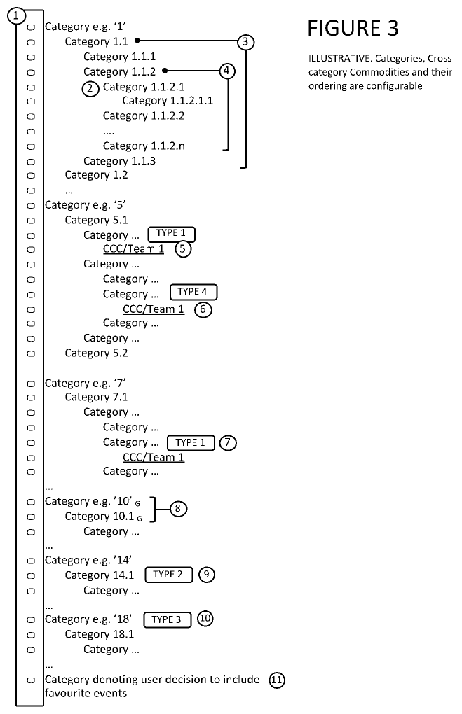

FIG. 3 is a diagrammatic representation of the hierarchy of the categories;

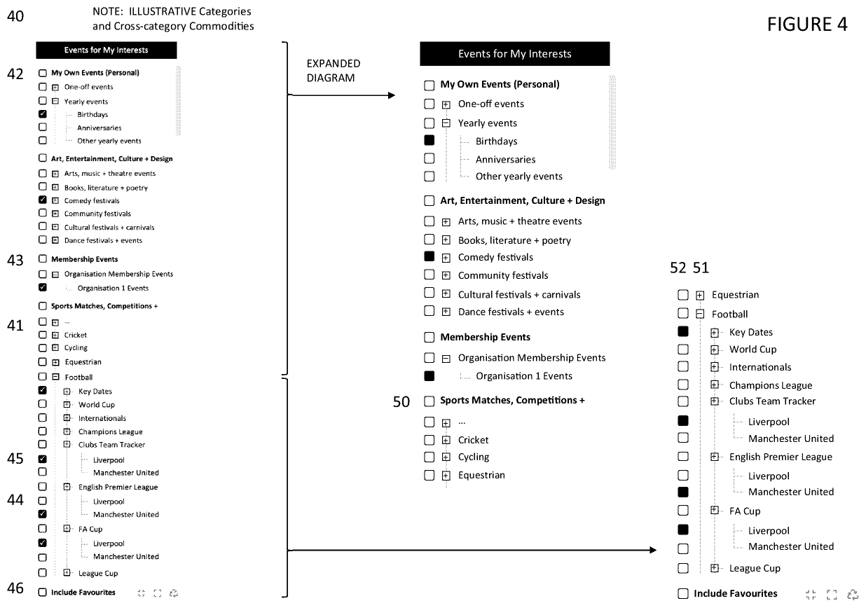

FIG. 4 is a diagrammatic representation of the Seamless Interests Setting Module, Category and Cross-category examples;

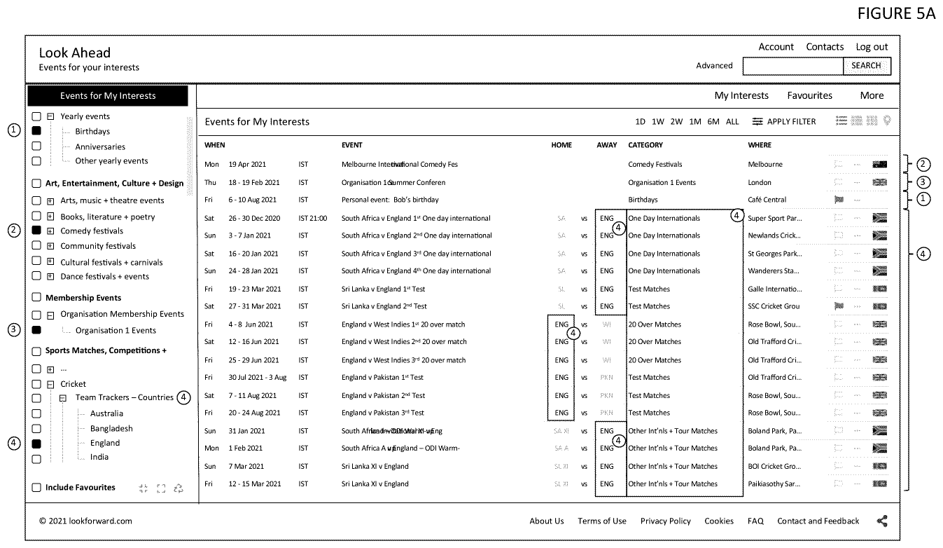

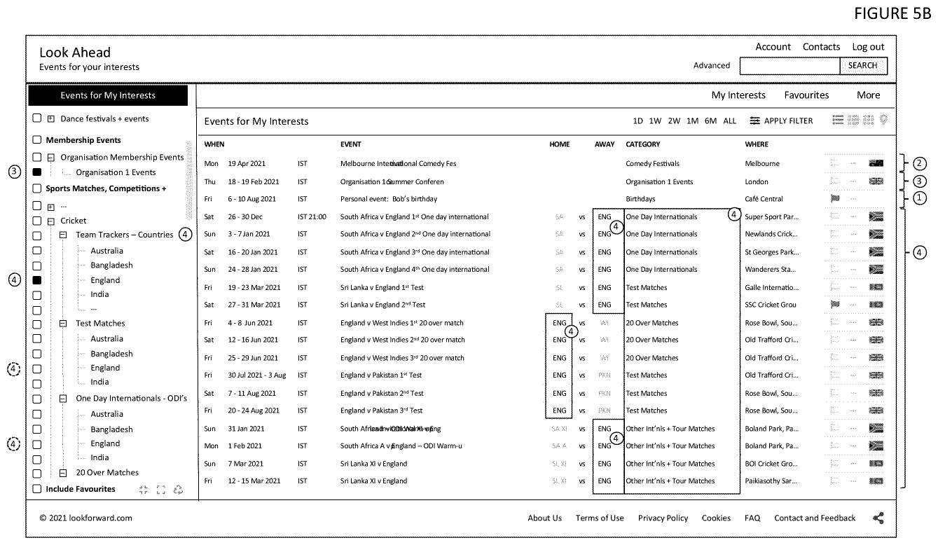

FIG. 5A is a screenshot of the List view with example data and worked examples, and FIG. 5B continues this with a continued (scrolled down) example

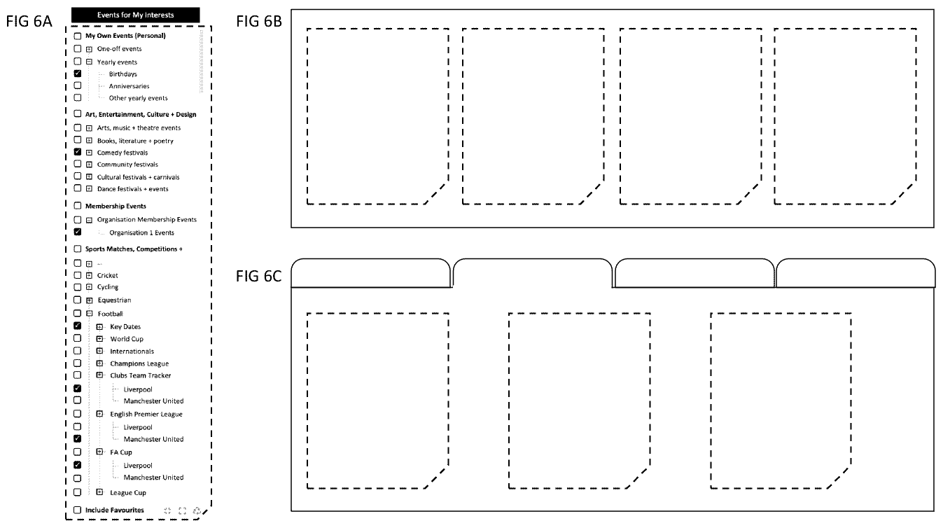

FIGS. 6A, 6B and 6C represent possible options for the Seamless Interests Setting Module user interface

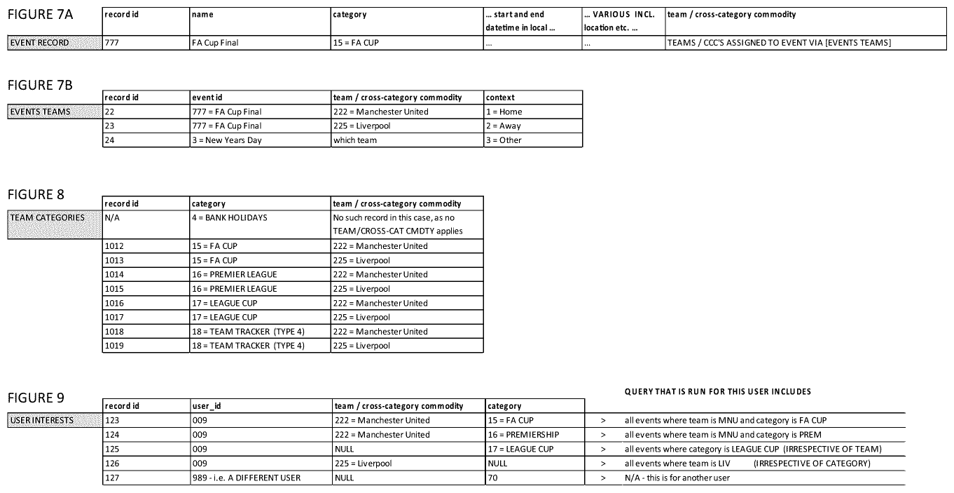

FIGS. 7A to 9 are representations of the database realisation of Cross-category Commodity interests setting and resultant query implications.

### DETAILED DESCRIPTION

### 1.3 Introduction—Users

Referring to FIG. 1, the events organisation system comprises a number of modules, which different classes of user can access, maintain and use. The classes of user comprise Events Information Providers 10, the general users, termed here Interested Individuals 11, Events Promoters 12, Membership Managers 13 and Advertisers 14, who together have access to the whole or part of the system, to maintain and change the modules, oversee the general operation of the system, and use the modules for their various benefits and purposes. The system will usually have an administrator group, who typically will also be the Events Information Providers 10.

### 1.4 Events

Events are things that happen at a point or period in time and are likely to be of importance or interest to one or more individuals. Events envisaged as being amenable to this system are wide-ranging. However, as easily relatable examples: a typical event could for instance be a sports event, having a date or location, being for a particular sport and league or competition, and typically involving two or more teams or competitors; another event could be a music concert, having a date and a location and being able to be classified as falling within one or more particular categories, for example rock, pop, jazz, reggae, dance and many more, or other broad categories or sub-categories.

### 1.5 Categories and Sub-Categories

An event may be classified within one or more Categories. Categories collect events into groups where selecting an interest in that Category of events implies having an interest in events belonging to it. Categories can be defined at broad levels or at increasingly detailed levels of specificity. For these increasing levels of specificity, Categories can comprise a number of sub-Categories, each of which may comprise further sub-Categories, down through increasing levels of specificity. Not all Categories will have sub-Categories. From here on, ‘Categories’ can be taken to mean Categories or sub-Categories.

A field of easily relatable examples is that of events which people choose to be involved in or to observe for social, belief and entertainment reasons. Examples of broad Categories for these events include: public holidays; sports matches for a given sport; religious events; music events for a given kind of music. (Other fields include for example, events for corporate or other organisational bodies, or events for coordination of say manufacturing activities.)

The varying levels of specificity of Categories and sub-Categories could entail for example not only sport matches generally but at lower levels of specificity, sport matches, football matches, football matches taking place in a given country, football matches for a given competition within that country, and within that competition perhaps the group of matches from quarter finals onwards.

Interests in Categories of events vary widely between Interested individuals 11, both across Categories and at various levels of specificity down through sub-Categories.

### 1.6 Underlying Challenges in Seeking Consolidated Events Information Across One's Interests

There are a number of challenges that the system seeks to address:

Essentially limitless combinations of possible interests
Even only in the field of social and related events, any one person's interests in events could span many areas, including for example upcoming global and international events and observances, national, regional, local or community celebrations and events, public holidays, clock switches, charity events, religious calendars, arts, music and many different cultural events, festivals, sports events across the many sports, competitions and leagues, natural events, political events, educational events, and so on
For any one of these interests, individuals may have differing levels of specificity of interest, as a simple example such as having an interest in all national celebrations, but only sports events for a particular sport at a particular level and only for cup competition matches at that level rather than league matches. Across the many areas and levels of specificity of interests, the possible combinations of interests are essentially limitless.
   Achieving consolidated rather than fragmented views of upcoming events across one's interests, given the planning interdependencies entailed
With time, location and other involvement-planning interdependencies between events it is important and beneficial to see upcoming events for one's interests together as a consolidated set, as opposed to being spread across sources or being prohibitively difficult to search for together. Being involved in one event for example may preclude being involved in others, whilst seeing events in relation to each other may indicate opportunities for involvement in events beyond those initially intended
Whilst introducing or copying events information from multiple sources into say one electronic calendar is possible currently, it typically takes the point-in-time instance of the information, needing to be repeated across sources over time, for newly arising events and for event updates
A successfully consolidated events set across one's broad and detailed interests would provide a strong basis for planning actions including filtering or sorting by preferred criteria, and for both prioritisation of and action on individual events.

As illustrated in FIG. 2A, and contrasted with FIG. 2B:

It requires an essentially unmanageable number of operations to seek and manage information for upcoming events across one's interests, even once
Computer and search engine technologies have greatly increased the efficiency with which specific information can be sought for given events, but even considering the speed and immediacy with which individual events' information can now be obtained, significant effort and a high number of operations are still required:
   to have actionable clarity of the specification of one's interests for searches, often instead searched by on an ad-hoc basis
   and then for each and every interest, to navigate, access and search the many available sources of information across many media and sources, for events matching a single interest and for useful information for each of those many events, configuring search engine syntax to search accurately and minimise the mass of non-events or non-relevant information arising as initial matches, and sifting out usable information from likely superfluous information
The difficulty obtaining events across the breadth and detail of one's interests is compounded further where relevance, importance and language differs across sources, geographic boundaries or other matters.

Further-increased effort if any location, venue or timeframe focus is needed, or clarity sought regarding the time zones of the event timings
The large number of operations and effort to seek upcoming events and events information across one's interests is further increased for each interest, if attempting to incorporate and align the information by:
   locations of particular interest
   venues of interest particular interest
   timeframes of particular interest
   and/or approach to time zones or specifically preferred time zones.

Additional effort for down-selection, collation, retention and/or organisation ready for further action
Further effort is necessary for any down-selection or identification of those of a particular interest individually, within the events discovered
or to collate, retain and organise the information for these many events so as be able to practically and efficiently make use of that information.

Multiple further operations for inclusion of one's personal events and where seeking to incorporate a view of one's restricted-access membership events
This high level of effort and the number of operations is increased further when seeking to incorporate one's personal events into the combined view
and when seeking to obtain, incorporate and manage membership-related events, which by their nature may require access to particular information sources rather than general, publicly available sources along with validation of one's access to the information.

Unmanageable further number of operations when incorporating varying interests in teams, genres or other key dimensions that traverse Categories
Yet further effort is required when seeking to qualify one's interests by, for example, preferred teams' involvement in the events, preferred genres of interest, preferred or most relevant areas of a country, or other dimensions that traverse Categories, because they present additional criteria, they apply across multiple Categories and because the manner of the interest in them can vary with respect to Categories and the events themselves.

All of this effort is to be continually repeated in the case of events information, as new events arise and existing events are often updated
Given the time-bound nature of events, searching for upcoming events (and for each event's various pieces of information) for one's particular combination of interests needs to be repeated over time, as new events inevitably arise, others complete and as information for upcoming events can often need to be updated due to changing circumstances. This is in contrast to most searches for static non-events information, which need not be repeated once known.

### 1.7 Challenges Faced and Opportunities Sought by Events Promoters, Membership Managers and Advertisers

Events Promoters 12, Membership Managers 13 and Advertisers 14 also face various challenges and seek opportunities in the provision of events information to their intended audiences. These are covered below, with explanation of the Events Submission & Moderation Module 28, the Membership Groups Module 29 and the Advertisements Module 30.

### 1.8 Events in Multiple Categories

Events may belong to one or more separate Categories. As an example, a famous national sporting event may belong to a Category for the corresponding sport—or if applicable a league or competition sub-Category—as well as a Category of major national events and other Categories.

### 1.9 Cross-Category Commodities

Cross-category Commodities are interests an Interested Individual may have with respect to one, more or any associated Categories of events. These are not sub-Categories, as they exist and apply across more than a single Category and must be treated as a single common entity across the applicable Categories.

Examples of Cross-category Commodities for social and entertainment events include those where an individual could have an interest:
in a given sports team's events, as the team may play matches in multiple competitions and leagues and participate in other signing or charity events
in a given genre of events, such as in comedy-related events
in events associated with a given region, district or county, which will likely apply across multiple Categories.

Importantly, an individual may have an interest in a Cross-category Commodity in one of three key ways:
1. irrespective of the Category of events: for example, where an interest is in a given football team's matches and their public events irrespective of the competition or league; in comedy-related events irrespective of the events being stand-up comedy, comedy film releases, comedy TV season starts, etc.; in a county's events, irrespective of them being agricultural events, sport events, cultural or community events, or so on
2. only with respect to one or more specific Categories of events: for example, only for a football team in a particular competition, such as for another nation's football matches during the football World Cup but not for all of that team's matches over time; only for comedy genre events where the event is either a stand-up performance or a film release; only for a county's agricultural and art events, not for other events for that county
3. or they may have an interest in a given Category of events to which one or more Cross-category Commodities apply, but irrespective of those Cross-category Commodities: for example, an interest in all football matches for a given competition, regardless of which teams are playing; or in upcoming film releases regardless of the genre.

Cross-category Commodities can themselves have levels of specificity, such as in the case of teams, where a given recognised sports club or recognised team may have various age group teams, still being recognised as being part of that same club/team. For simplicity, as sub-Categories are explained and referred to throughout, sub-Cross-category Commodities can be taken to follow the same considerations.

The challenges in seeking a consolidated set of events for one's interests are significantly compounded when trying to seek events for one's Cross-category Commodity interests in conjunction with other interests, in the ways set out above. Such searching is not provided for meaningfully practically with existing technologies including typical syntax-driven searching, and particularly not practically when sought to be repeated over time.

### 1.10 Cross-Category Commodities as Information and Applicable Contexts

Cross-category Commodities are an aspect by which individuals' interests in events exist, but are often also important pieces of event information in their own right, whether or not an interest in an event was driven by it. To know that a team is involved in a sports match, for example, is often important, whether or not an interest in the event was because of that team. Further,
as with Categories, events will often see the applicability of more than one Cross-category Commodity—again in the example of sports teams
and it is important to know each of the applicable Cross-category Commodities according to its context for the given event—i.e. according to the manner in which it is relevant to the event. In the case of sports matches and teams for example, to know the ‘home’ or ‘away’ context of each, i.e. the manner in which that Cross-category Commodity is relevant to the event. The relevance of the Cross-category Commodity to the event is qualified for such purposes with the its Cross-category Commodity ‘Context’.

### 1.11 Public, Personal and Membership Events and Categories

Events may be:
1. Public events, which generally have the following characteristics: awareness of and access to these events is essentially open to one and all (albeit perhaps with ticketing or other requirements); no particular security handling is necessary regarding the availability of their information; one, more or no Cross-category Commodities may apply to them. Note, in some fields, no privacy or access-constraint considerations may be needed regarding the awareness of events. Events in those fields may essentially all be considered ‘Public’
2. Personal events, which generally have the following characteristics: awareness of and attendance of these events may only be for the individual in question, or a selected group of people to which the event is extended, and not other people more widely; the efficiency and effectiveness of retrieving information for these events distinctly or along with other kinds of events is as important as for other events, such that ideally the tight controlling of these events to the applicable individual(s) does not hinder the awareness of and provision.
3. Included in the above, Personal events that are recurrent in some respect. As can non-Personal events, particular personal events follow a recurrent pattern. Examples are birthdays and anniversaries. It is important for efficiency that the defining of such recurrent events does not need to be repeated fully for each instance. Also, it may be useful to gather similar but non-recurrent events alongside corresponding recurrent ones, such as in the case of a birthday party event where it may be useful to see information for it alongside that for other birthdays, but it is unlikely to be repeated each time in the very same form or with identical attendees
4. Membership events, which generally share aspects in common with both Public events and Personal events. Awareness of and access to these events may need to be broader than a single individual person or people associated with them, but materially more restricted than for public events; awareness of the events and provision of the information for them needs to be constrained to people that are members of the corresponding organization or membership group.

Whilst many technologies exist to manage and arrange Personal event information electronically and it is possible for example to import public event records into one's electronic calendar or similar application, a high number of operations would currently be required to seek to achieve a consolidated view across ones many interests also including one's Personal events, and this would need to be repeated over time. Any events information imported would also need to be checked repeatedly for necessary updates.

Whilst clubs, organisations and other membership groups can establish their own systems for provision of events information and limit access to this information, it would be more useful across such membership events:
to interested individuals to have the option of accessing that information through a consolidated view alongside public and personal events of interest, still being constrained to their applicable memberships;
to interested individuals to be able to obtain this data without further access controls at the point of obtaining it;
for membership groups not to have to establish their own systems for provision of the required data, whilst also positioning the events information to be seen and consumed more frequently than in a stand-alone location.

### 1.12 Category Natures

Categories may themselves share a common nature with others, with events belonging to those Categories being of particular interest together. As an example, Categories assigned and sharing a ‘holiday/vacation’ nature may include a ‘Public holiday’ Category and a ‘Holiday/vacation’ Category. It may be of interest to an individual to be able to see such events together, as well as by their individual Categories.

### 1.13 Geodomains

As a separate matter from people's individual interests in events, the relevance of events to different broad groups of people often differs as does the importance where relevant, and different event information wording, language or syntax may be necessary. Geodomains represent broad groupings of individuals to which large sets of events are generally relevant or not relevant, for which the importance may differ, and/or for which information wording, language or syntax may be differed.

Geodomains may include for example:
geographic groupings of individuals, using sport examples. Relevance: Kabaddi as a sport is likely of more relevance to individuals in India than to those in Central America. Importance if relevant: Rugby generally has a higher level of importance to people in the UK than American Football, and vice-versa for people in the USA. Wording used: cricket matches taking place within the Indian Premier League, given the general level of familiarity with these matches in India, might be referred to as ‘IPL’ in India, but as ‘Indian Premier League’ matches elsewhere
age groupings of individuals, such as children for example, to which information on say beer festivals might not be made available and the nature of information for events generally might also be differed
broad groupings of individuals requiring different languages for events information, with English and Spanish speakers for example recognising ‘new year’ and ‘año nuevo’ for the same event
other groupings of individuals, such as members of organizations, for which events are more relevant or less relevant, more or less important, or for which the language or syntax may need to be differed.

The difficulty obtaining events across the breadth and detail of one's interests is compounded where such relevance, importance and language requirements differ across sources and geographic boundaries or other matters.

### 1.14 Locations, Venues, Timezones and Timeframes of Interest

Events have a set of parameters which may be associated with them. Examples of such possible parameters include, the Location of the event, the Venue, the Time Zone of the event and the Timing of the event.

Locations of events might be either:
specific map locations, by for example latitude and longitude positions
a specific map address, post/zip code, known town or city, area, etc.
descriptive or broader summary locations.

Locations of interest to an individual may be:
a default location relevant to the individual such as where they live
their roaming location, if currently on the move or in a new location
a selected location of temporary interest to a user for one reason or another
or of a location derived from some other input such as that of a previously reviewed event or related to a separate search.

Locations generally need to be considered in terms of distance from or radius around a given point, in a preferred unit of measurement.

Individuals' interests in events may be qualified either over time or temporarily by the Location(s) of events and the Location of an event is also often itself an important piece of information for each event whether or not an individual is interested in that event because of its Location.

Whilst current search technologies allow for some level of location specification within event searches across multiple interests, bringing accuracy only where fortunate, this typically requires repeated specification of additional search syntax for the location, detailed trial and error specification to avoid the ambiguity associated with multiple locations having a common name, and/or general assumptions within a system that the user is interested in events related only to their current location.

Venues of events might be recognized locations, for example given music or exhibition venues, religious buildings, sports stadiums, etc., and might be referred to descriptively or recognized from a defined list.

Individuals' interests in events may over time or temporarily relate particularly to the Venue(s) of those events. The Venue of an event is also often itself an important piece of information for the event whether or not an individual is interested in that event because of its Venue. Searching for events only for a set of Venues presents similar problems to those faced when searching with a focus on a given Location.

Locations and Venues can themselves act as meaningful factors by which events can be collected or grouped, and can therefore also established as Categories in their own right, but it is often useful to treat them as events aspects additional to Categories used for non-location, non-venue purposes.

Time Zones are as commonly recognized and preferences for them for events information can differ between individuals in a number of ways. Time Zones:
relate to a country or other physical area(s) with an arranged common reference to the time of day or night
and in some cases are qualified with an alteration at different times of the year, for daylight saving or other alignment purposes.

The Time Zones of interest to an individual may be:
the local Time Zone of each event, likely to differ across events
the Time Zone for the individual's roaming location
another Time Zone of interest to a user for one reason or another, and these may be applied to provide the user with a uniform approach when dealing with event times or time frames (which are discussed below).

The Timeframe of an event (often qualified by Time Zone) is of course normally an important piece of information for the event. Timeframes can be:
a specific start date (and time) and/or a specific end date (and time), and the period of time between them if both are important
a more loosely defined period of time such as ‘late autumn’.

It is often important to know both:
whether that Timeframe is stated in the event's local Time Zone; the individual's current Time Zone; or which other Time Zone if applicable
and in what way daylight saving is being treated if applicable,
   and to have the event displayed following the applicable Time Zone approach.

Events searched for in search engines are not at all easily constrained to preferred Timeframes, other perhaps than being constrained in search engine algorithms to those that are coming up soon: most search engines' syntax-driven searches do not readily enable Timeframe constraint, and amending the Timeframe of interest would require repeated search effort. Specifying date constraints individually for each of many searches across one's breadth and depth of interests and events necessarily cannot match the efficiency of specifying it only once. Obtaining events timing information across multiple events in one of a number of possible Time Zone approaches presents a further complication still.

Unmanageable without these challenges, the number of required operations increases still further, increasingly unachievable, when seeking to constrain events across one's interests by Location, Venue or Timeframe and to see the Timeframes by one of a number of preferable Time Zone approaches.

### 1.15 Individually Preferred Events

Whilst individuals can have interests in Categories of events as and when events for those Categories arise, they may also have a particular interest in specific events individually. This may be where that specific event interest complements having an interest in the Category itself, such as having an interest in a particular sports league but also particularly in a local derby match within that league; or where they have a specific event interest but not also in the corresponding Category, such as only having an interest in the local derby match and not the particular league more generally. As described later, the Interested Individual can mark events as being of particular interest individually.

Currently, demarcating or storing specific individual events as being of particular interest typically involves having to incorporate the event into one's own calendar application and reviewing it at source for any updates. This brings further effort still, across one's interests.

### 1.16 Modules Introduction

As set out in FIG. 1, the present invention comprises the following modules:
Interests Framework Module 20
Access and Geodomain Determination Module 21
Modules enabling the Interested Individual 11's core activity:
   Seamless Interests Setting Module 22, and the following sub-modules: Location Preference 22.1; Venues Preference 22.2; Time Zone Approach 22.3; Timeframe Preference 22.4
   Single Demand Upcoming Events Module 36
   Actions Module 38
   Personal Events Insertion Module 32
Membership Groups Module 29
Manage 3^{rd} Parties Module 26
Events Population Module 24 and the Events Auto Population Module 25 along with external systems and the internet
Events Submission & Moderation Module 28
Advertisements Module 30.

### 1.17 Interests Framework

Events Information Providers 10 have access to the Interests Framework Module 20, which establishes the framework for the data held and processed by the other modules, and controls the operation and relationship of the other modules. In particular, the Events Information Provider 10 uses it to establish and control the following, and the applicability relationships between them:
Categories and sub-Categories. Each Category may include sub-Categories at increasingly detailed levels as applicable, through parent-child relationships between the Category and its sub-Categories, ideally classifiable in a hierarchical tree structure.
Cross-category Commodities and relationship with given Categories
Category Natures
Geodomains. Geodomains are defined in the Interests Framework Module 20 to reference the corresponding broad groups of users. The relevance of each Category and Cross-category Commodity per Geodomain and any differing wording/syntax to be used in naming and other descriptive information for the Geodomain can be defined in the Interests Framework Module 20, ideally through Geodomain-specific sub-instances of Categories and Cross-category Geodomains (Category Geodomains' and ‘Cross-category Commodity Geodomains’)
the ordering and any Geodomain-specific ordering of Categories and Cross-category Geodomains, reflecting the importance of each for that Geodomain, later referenced by the Seamless Interests Setting Module 22
complete sets of Time Zones and Venues.

Specifications in and management of the Interests Framework Module 20 is configurable without the need for any system development activity. Categories and their sub-Categories, Cross-category Commodities, Geodomains and Geodomain-specific instances can all be established independently and the corresponding relationships assigned.

### 1.18 Interests Framework—Category Types

The system is able to handle diverse types of events. As described above, differing types of Category and events can have different interest-selection, information-provision and security-handling requirements. Public events can be provided to users generally; Personal events require access constraint to the applicable user and any other users to which that user has chosen to extend the event; Membership events must be readily provided to applicable users and constrained to them. These differing requirements and the associated rules and events definitions can be managed within the system through different Category Types. Also described above are the different ways in which a user may have an interest in a Cross-category Commodity: either specifically with respect to one or more specific Category(ies) to which the corresponding events belong, or irrespective of the Categories to which the events belong. Or the user may have interests in a Category(ies) to which Cross-category Commodities relate, irrespective of the Cross-category Commodities. Again, these differences can be implemented through Category Types.

The same differentiations can be achieved through comparable flagging or data relationship approaches, such as assignment of Types at the event level—with the system altered to assign Types to events, carried out in the Events Population Module 24 and Events Auto Population Module 25—and reference to Category Types includes such equivalents.

Categories can be assigned their Category Type in the Interests Framework Module 20, as follows, with these numbers used for explanatory purposes.
1. Public event Categories are assigned a Category Type of ‘1’, a ‘normal/standard’ Category
2. Personal events are assigned a Category Type of ‘2’
3. Membership events Categories are assigned a Category Type of ‘3’.

Cross-category Commodities are ideally associated with a Category in all cases, to support their selection in the Seamless Interests Setting Module 22. Category Types are set for those Categories as follows, for Cross-category Commodities applying:
4. irrespective of the Category of events: the Cross-category Commodity is associated with a Category assigned a Category Type of ‘4’—a ‘tracker’ Category, driving the ‘tracking’ of the Cross-category Commodity across all events associated with it
5. only with respect to one or more specific Categories of events: the Cross-category Commodity is associated with each of those Categories and each Category is assigned a ‘normal’ Category Type of ‘1’
6. or they may have an interest in a given Category of events to which one or more Cross-category Commodities apply, but irrespective of those Cross-category Commodities, with those Categories assigned a Type of ‘1’.

The Events Information Provider 10 groups and orders the Categories and Cross-category Commodities configurably as they choose, for reference and use by the Seamless Interests Setting Module 22. This includes where necessary ordering differentiation by Geodomain, for any differing levels of importance.

2.1 Seamless Interests Setting Module

The Seamless Interests Setting Module allows the Interested Individual to rapidly specify their interests in upcoming events across their multiple-dimension interests and without having to navigate security or privacy controls in doing so.

The interests of the Interested Individual 11 are ideally input by the Interested Individual 11 by means of a user interface 40, or variations displayed in FIGS. 6B and 6C. This is provided by the Seamless Interests Setting Module 22.

Resolution into a Single Selection Dimension, and Coverage Across Interests and Dimensions

Referring to FIG. 4, the Seamless Interests Setting Module 22 resolves all of the multiple Category and Cross-category Commodity interest options in the Interests Framework Module 20, referencing the Membership Groups Module 29, into a single seamless selection dimension presented to the Interested Individual.

The Interested Individual 11 need not understand, seek to map or spend significant effort navigating their interests. In significant contrast to the many operations that would be needed with existing solutions, in only seconds they are able to:
select simply from the Seamless Interests Setting Module 22 their interests in one seamless dimension, i.e. with these options displayed to the Interested Individual 11 for selection:
   in a simple linear option list in a manner where there is no differentiation between them,
   other than their vertical position and any indentation of sub-Categories
   noting the simple linear option list may, given its length, be divided across the width of a display for practicality, as illustrated in FIGS. 6A, 6B and 6C.
cover without effort the multiple dimensions it logically comprises
cover all interests across the breadth and levels of specificity of their interests
efficiently avoid duplicated or repeat selection effort, due to a number of key features described here.

The Seamless Interests Setting Module 22 resolves and presents the interest options to the Interested Individual in a single selection dimension across all of the following:
1. Public event Categories, e.g. 41, at a high level and down through levels of increasing specificity as they exist
2. Personal event Categories, e.g. 42, at a high level and down through levels of increasing specificity as they exist, with no requirement for any further access control action. Whilst an Interested Individual's Personal events are always implicitly of interest to them, the presentation of interest options here is for the user's preferred selection at the time required
3. Membership event Categories, e.g. 43, to which the Interested Individual 11 has been assigned access, with no requirement for any further access control action by the Interested Individual 11. The Seamless Interests Setting Module 22 reads the Membership event Category assignments for the Interested Individual 11 from the Membership Groups Module 29, to determine which are to be presented to them
4. Cross-category Commodities for selection in conjunction with one or more specific Categories, e.g. 44
5. Cross-category Commodities for selection irrespective of Category, i.e. for any and all Categories, e.g. 45
6. Also resolved into the single dimension of selectable interest options, a binary decision item 46 as to whether the Interested Individual 11 wants to see individually preferred events together with events for the selections above.

Not all of the above sets need be implemented in all embodiments, and events in a variety of fields—for example within an organisation—may require no security or access constraints beyond an overall system-access requirement and may essentially all be ‘Public’ events.

In conjunction with the setting of Category and Cross-category Commodity interests and as explained subsequently, any and all of the following can be set at any time to constrain the events more closely to the user's current interests:
7. a Location of interest, with a preferred radius
8. Venues of interest
9. a Timeframe of interest
10. a preferred one of a number of Time Zone approaches.

Key Features of the Preferred Solution

Referring also to FIG. 4, in a preferred embodiment:
1. Specific interest options are displayed in a hierarchical tree form, which may be collapsed or expanded in order to hide or show the different hierarchies of interests. At the root level as an example one of the root nodes may be Sports events as a Category 50. At a second level, the Sports events may be subdivided into Cricket, Cycling, Equestrianism, Football etc. At a third level, Football may be subdivided, for simplicity of the example, into Key Dates, World Cup, Internationals, Champions League, English Premier League and Team Tracker. Each of these nodes may at a fourth level have various Cross-category Commodities (teams in this case) such as Liverpool, Manchester United, etc.
2. Each node may include an expansion toggle 51 which may be selected or deselected to either display or hide the nodes of the next lower level
3. Adjacent to each interest option and grouping of interest options at each level of the hierarchy, a checkbox 52 allows the Interested Individual 11 to select or deselect nodes of Categories and/or Cross-category Commodities in order to store this interest in the Seamless Interests Setting Module 22. This binary selection of each interest provides for precision of interest selection, in contrast to open-syntax searching on a best-effort basis likely requiring multiple attempts
4. Categories are positioned with increasingly specific sub-Categories underneath them
5. Public, Personal and Membership event Categories are displayed in the same manner as each another, with no access control requirement steps needed in their selection
6. Cross-category Commodities are each positioned under Categories/sub-Categories at given levels, appearing in the same manner and being selectable seamlessly as if being sub-Categories, but bringing with them the functionality of Cross-category Commodities
7. As illustrated in FIGS. 6A, 6B and 6C, the hierarchical tree form may be implemented in one single vertical plane 6A; or split in sections and positioned next to each other 6B; including where then separated by, say, tabs 6C.

By this means, the Interested Individual may navigate the events in an organised manner and select which Categories, Cross-category Commodities and combinations of these are of interest to them. Any number of interests may be selected in this way, with the overall combination of interests likely different from other users.

Key interest-selection efficiencies exist in the selection of Categories and Cross-category Commodities:
8. In one embodiment and as optionally preferred by the user, the single selection of an interest in a Category covers without further effort the selection of an interest in all of its sub-Categories and therefore the associated events:
   in one implementation, this is made effective through the Seamless Interests Setting Module 22, setting all iterative levels of sub-Categories of a selected (sub-)Category as interests too
   in another implementation this is made effective through the Single Demand Upcoming Events Module 36, described below, deriving at the time all iterative levels of sub-Categories of a selected (sub-)Category as interests too, and including their events in the events provision
   this reduces the Interested Individual's number of operations and effort, and again reduces the effort if later de-selecting the Category
9. For Cross-category Commodities selection in conjunction with one or more specific Categories, the positioning of them under the applicable Category(ies) drives seamless selection of that combination in one action by selecting the Cross-category Commodity, with the combined interest interpreted and effected as such
10. For Cross-category Commodities selection for events for any and all Categories, the positioning of them under a Category of the applicable Category Type (4) allows for seamless selection of the fact by the user in one action, with the Categories-wide Cross-category Commodity selection is interpreted and effected as such. This prevents the Interested Individual having to carry out multiple further operations to specify the Cross-Category Commodity as an interest in conjunction with each and every applicable Category

There can be many interests per Interested Individual 11, a great variety of interests and many combinations of interests across the Interested Individual population, with each interest also existing either at a high level or many combinations of lower levels, which can all be made visible depending on Geodomain and displayed with wording/syntax according to that Geodomain. However, the Interested Individual sees simply a seamless selection set, with all of the interest and varying security dimensions resolved and displayed to them in one seamless selection dimension, such as a column of selectable check boxes, although other display options are obviously conceivable.]

Geodomain Dependency and EIP-Preferred Ordering

The Interested Individual's 11 access to the system and applicable Geodomain are determined in the Access and Geodomain Determination Module 21. The Seamless Interest Setting Module 22 only presents those Categories and Cross-category Commodities applicable to the Interested Individual's Geodomain, as set in the Interests Framework Module 20 and displays them with the corresponding wording, language or syntax for that Geodomain. In one embodiment this is implemented through the existence of Geodomain-specific sub-instances of Categories and Cross-category Geodomains (Category Geodomains' and ‘Cross-category Commodity Geodomains’). The display ordering of the interest options follows is as set by the Events Information Provider's in the Interests Framework Module 20, including any Geodomain-specific ordering.

Almost all Operations Removed and Accuracy Increased

The Seamless Interests Setting Module 22 enables the Interested Individual 11 to specify their interests in a number of seconds, and only to need to do this once. (They can update their interests if and when preferred.) As events information needs to be sought repeatedly due to the time-bound nature of events, these aspects greatly reduce the number of operations required for any one events information effort across ones interests, including due to the:
binary decision by the user for each presented interest option
seamless presentation and selection of these across interests and types of interest in one place
resolution of the various access requirements across interest types
sub-category implied selections
implied selection of all Categories for applicable Cross-category Commodities, and specific Categories where applicable.

These are each and together materially more efficient than open-syntax searches across sources, across one's interests, necessarily to be repeated over time as events newly arise or are updated; contrasting greatly with the number, complexity and repetition over time of the operations to be carried out to search for events information with current technologies, for the same breadth of types of interests, combinations of interests and varying levels of specificity.

Furthermore the Seamless Interests Setting Module 22 drives a greater matching success of events information to the Interested Individual's interests, than provided for by common open-syntax queries, as open-syntax and context-absent searches have an unavoidable element of uncertainty with other un-sought subject matter also corresponding to the search syntax, likely requiring repeat attempts. The explicit context provided by the surrounding Categories, sub-Categories and Cross-category Commodities in the Seamless Interests Setting Module 22 provides for increased accuracy. Again, this drives a reduction in the number of operations required, at any one time and repeated over time for newly arising events.

Interests Setting as Instructions to the Single Demand Upcoming Events Module

As will be set out in more detail below, at any time required by the Interested Individual 11 and on a single demand with no other events retrieval action, the SDEUM (Single Demand Upcoming Events Module) 36 instantaneously provides the upcoming events for all of their seamlessly set interests.

The interests specified by the Interested Individual in the Seamless Interests Setting Module 22 are stored as instructions to the SDUEM 36. The instructions are to include all of the corresponding events as follows:
1. Public event Category: include all events for this Category and iteratively all of its sub-Categories
2. Personal event Category: include all events for this Category and iteratively all of its sub-Categories, where the events belong to the given Interested Individual 11 or have been shared with this Interested Individual 11
3. Membership event Category: include all events for this Category, with this Category only having been displayed for selection to the Interested Individual 11 where their access has been confirmed previously through the Membership Groups Module 29
4. Cross-category Commodity in conjunction with a specific Category(ies), Category Type 1: include all events that match the Category(ies) and this Cross-category Commodity
5. Cross-category Commodity irrespective of Category, Category Type ‘4’, ‘Tracker’: include all events for this Cross-category Commodity. Category Type 4's imply applying no Category constraint, so all events this Cross-category Commodity are included irrespective of their Category
6. If selected from the associated binary decision item: include all events individually preferred by the Interested Individual 11.

The interests are stored for use indefinitely, until and if the Interested Individual chooses to update them.

Database Realisation of Cross-Category Commodity Interests Setting

A possible Database realisation of the Cross-category Commodity interests is as follows. For practicality here, as the Cross-category Commodities in this example are teams, Cross-category

Commodity is referred to by the word ‘Team’:
Referring to FIG. 7A the events database will typically comprise an entry of each event name, along with a unique record ID. Most events will have a date/time value and may have a location and other values. The event will also have a Category value, which, through parent-child relationships with other Categories, determines where it appears in the hierarchical tree of the display, and how it is retrieved in a search when a query is executed, as described separately
Referring to FIG. 7B, a further table may be a database of Event Team data. Again, each data will have a unique record ID. It will also include an entry for the event, the Team(s) involved, and further information relevant to the event. In this example, the event Team data includes two teams, participating the ‘FA Cup Final’ event, and Context (home/away) information on the Team (the Cross-category Commodity Context).
Referring to FIG. 8, a further table may be a database of Team Categories, relating Teams (Cross-category Commodities) to the Categories to which they apply, in this case including Teams taking part in the FA Cup competition. Again, each Team Category data will have a unique record ID.
   In the example here, Manchester United and Liverpool are Teams taking part in the FA Cup competition, the Premier League, and the League Cup
   Additionally, they are related to a Team Tracker category which has a Category Type 4, such that the user will be able to choose to select either of these Teams with respect to any and all of the events in which they are taking part
Referring to FIG. 9, a further table may be a database of User Interests data. Again, each data will have a unique record ID, and an associated user ID. It will also include an entry for the Category and/or the Team (or other Cross-Category Commodity), if this has been selected in the user interface. In the example given here, the Interested Individual user has recorded his interest in Manchester United when playing specifically in the FA Cup and the Premiership. They have also recorded their interest in the League Cup for all teams—so in this instance, the Cross-Category Commodity field is null. They have also recorded an interest in Liverpool for any competition, so the Category field is null. They will have done this by way of Liverpool's relation to and display under a Team Tracker type Category, Type 4.
The interests of all Interested Individual users may be recorded in this database, the last entry line being that of a different user
So, referring to FIG. 9, an Interested Individual's (user ID 009 in this case) interests are recorded with:
   for each Category interest where no Cross-category Commodities are relevant or have been specified, a record specifying the Category and NULL Cross-category Commodity
   for each Category held in conjunction with a specific Cross-category Commodity (and vice-versa), a record specifying the given Category and Cross-category Commodity
   for each Cross-category Commodity regardless of the Categories to which the events relate, a record specifying solely the Cross-category Interest, with NULL Category.

In order to display the events relating to the Interested Individual's recorded interests, the queries are generated or events are included as shown at the end of FIG. 8, and the results presented to the Interested Individual.

The binary decision item as to whether the Interested Individual wants to see individually-preferred events together with events their Categories, Cross-category Commodities and applicable combinations, can be carried out by way of a specific flag for the user, or selection of a specific Category recognised for that purpose.

Locations of Interest

The Interested Individual 11 can specify a Location of interest simply using the Location Preference sub-Module 22.1, if they want the events provided to them to be constrained to this Location and a given radius from it. With Locations of interest being map locations, specific addresses, post/zip codes, known towns, cities or area, etc., along with a preferred radius in miles or kilometres, the Interested Individual can specify as a (temporary or lasting) events-provision constraint:
a default Location for reference generally, such as where they live
a specific Location of interest to them for one reason or another at a given point in time
their roaming Location, if on the move or in a new location
a Location derived from some other input such as that of a previously reviewed event or related to a separate search.

Venues of Interest

The Interested Individual 11 can specify one or more Venues of interest simply using the Venues Preference sub-Module 22.2, if they want the events provided to them to be constrained to these Venues. The Interested Individual 11 can specify as a (temporary or lasting) events-provision constraint one or more venues from system provided lists.

Note, Categories and Cross-category Commodities can feasibly also be used to group events according to the Venues and Locations in which they are taking place, but Venues and Locations are often better treated as events-provision constraints separately from/additional to Categories.

Preferred Time Zone Approach (and Time Zone)

The Interested Individual 11 can specify their preferred Time Zone approach simply using the Time Zone Preference sub-Module 22.3 or leave it to be derived from their location by default if their location is agreed to be known. The Interested Individual can specify a preference:
for the Time Zone of events provision to be taken from the local Time Zone of each event, allowing for daylight saving differences where required. The Time Zone provided across the events will often differ
for the Time Zone of events provision to be taken from the Time Zone they are currently in where known, also allowing for daylight saving
for the Time Zone of events provision to be as per a specified preferred Time Zone, also allowing for daylight saving.

Timeframes of Interest

Time as a Core Implicit Parameter

The Interested Individual 11 can specify a Timeframe of interest simply using the Timeframe Preference sub-Module 22.4, if they want the events provided to them to be constrained to this timeframe. The Interested Individual 11 can specify as a (temporary or lasting) events-provision constraint:
a specific date (and time) before which events will not have ended
a specific date (and time) before which events will have started
the combination of these if a range is important.

These are for one-off events, or the applicable instance(s) of a recurrent event.

Interests Amendment Whenever Chosen

Whilst interests only need to be established once, the Interested Individual 11 can update their interests equally simply, at any time thereafter as they choose, as their interests evolve or for temporary interest-combination purposes.

Once set up, the selection set provides the query constraints that provide the resultant up-to-date events output immediately whenever sought. All these interests and sub-interests are stored in the Seamless Interests Setting Module 22; this means that in order to view upcoming events, calendars etc, the Interested Individual 11 need only request this and the Interest Queries are performed with the pre-stored interests without further input necessary by the Interested Individual 11.

### 2.2 Access, Anonymity and Shielding

Interested Individuals 11 identify and authenticate themselves on the system using the Access and Geodomain Determination Module 21 in order to set and update their interests and obtain sets of events accordingly. Having done so:
no further access activity is required regarding access to events information. Importantly they do not need to access multiple information sources for the events information
   with no further access action required to access Personal events
   nor to access Membership events or Membership event Categories for which their access has been confirmed via the Membership Groups Module 29
all of their interests are held within the system and whilst they can then obtain events information across a multitude of Categories and Cross-category Commodity interests and from multiple ultimate sources of the information, both their interests and their events information-sourcing activity are shielded from:
   any interfaced event sources and the associated organisations
   any Events Promoters 12 using the system
   any Membership Managers 13 using the system
   any Advertisers 14 using the system
   the Events Information Provider 10.

In the context of data privacy drivers and regulations such as GDPR, this:
provides a single point of control for the Interested Individual 11, greatly reducing the number of interest exposures between parties
and from the perspective of the Events Promoters 12, Membership Managers 13, Advertisers 14 and interfaced events information source organisations, they are able to provide their events and associated information to the Interested Individuals 11 whilst having no access to and therefore no burden of responsibility for the data privacy of those Interested Individuals 11.

### 2.3 Geodomain Determination

The Interested Individual's Geodomain is determined by the Access and Geodomain Determination Module 21, by methods including:
direct selection by the Interested Individual 11
for geographic Geodomains, the location/geographic area of the Interested Individual 11 where permission to access the location information has been provided, for example from their IP address or phone location, or from a country specified by the Interested Individual 11
the Events Information Provider 10 setting up the system for distinct groups of users, by organisation for example.

The Access and Geodomain Determination Module 21 also enables the Interested Individual 11 to register initially and maintain their account information such as their profile name and any communication preferences.

### 2.4 Direct Individual Interests Selection

The nodes presented within the Seamless Interests Setting Module 22 can also be selected individually by the Interested Individual 11 (as hyperlink text for example) to seek events corresponding only to that node's individual Category or Cross-category Commodity in conjunction with a Category. As this does not require the storing of the Interested Individual's 11 interests, Interested Individuals 11 that have not (yet) identified and authenticated themselves on the system can also select this option for Public events.

### 3. Events Population+Associated Activities

### 3.1 Events Population Module

The Events Population Module 24 holds data on forthcoming events. This will include a database or distributed databases. The Events Information Provider 10 uses the Events Population Module 24 to:
populate and update the events information, as new events arise and existing ones require update
assign events to Categories and to Cross-category Commodities and combinations thereof, including qualification with any Cross-category Commodity Contexts. Whilst events can be assigned to one or more Categories, each event might be assigned a primary Category, for subsequent reference purposes
introduce Geodomain-specific sub-instances of events—‘Event Geodomains’—with Geodomain-specific wording
specify as applicable each event's Location, Venue, Timeframe and local Time Zone.

Events may have parameters including their Location, Venue, Timeframe and local Time Zone.

Users other than the Event Information Providers 10 may also be provided direct access to the Events Population Module 24 for the population of their events.

In the field of public events, Event Information Providers 10 can have many personal, charitable, revenue or other reasons for providing events information, including for a specific subject areas. This may be complementary to other information provision or particularly for example for event ticket sales or other commercial activities. They are currently limited in how efficiently and effectively they can provide events information. Improved enablement of events information provision can bring increased:
retention of and more frequent traffic from Interested Individuals 11
commercial opportunity accordingly
cross-over information provision and associated follow-on opportunities, given the consolidated view across interests
use by Event Promoters 12 and a fuller proposition in turn for Interested Individuals 11
use by Membership Managers 13 for the provision of events information, resulting too in further ease for Interested Individuals
residual time for Interested Individuals' 11 to engage in events-related commercial activity, given the ease of the core search activity.

### 3.2 Events Auto Population Module

The Events Auto Population Module 25 introduces events information into the Events Population Module 24 via upload, system interface, scraping from public sources or other agreed-access information sources, or other automated methods.

The Events Auto Population Module 25 assigns events to Categories and to Cross-category Commodities according to mapping rules configured in the module by the Events Information Provider 10. The Events Information Provider 10 can also carry out these assignments within the Events Population Module 24.

The Events Auto Population Module 25 is administered by the Events Information Provider 10 and used to orchestrate the various automated methods, and map internal Category and Cross-category Commodity values with corresponding external system values where required. Where their access is enabled, it can also be used by Events Promoters 12 and Membership Managers 13 to upload their events, running agreed interfaces for example.

### 3.3 Manage 3rd Parties Module

A Manage 3^{rd} Parties Module 26 is accessible by the Events Information Provider 10, using which they set up and administer the Events Promoters 12, Membership Managers 13, Advertisers 14 accounts and access along with their Category, Cross-category Commodity, Geodomains and events access rights.

### 3.4 Events Submission & Moderation Module

The Events Submission & Moderation Module 28 allows Events Providers 12 and Membership Managers 13 to introduce information on forthcoming events into the Events Population Module 24 and update existing events as required, to assign the events to Categories and Cross-category Commodities, qualify with any Cross-category Commodity Contexts and add Event Geodomain information.

Events Promoters 12 and Membership Managers 13 can also upload events or input them via an interface or other automated method, using the Events Auto Population Module 25.

The Events Information Provider 10 uses the Events Submission & Moderation Module 28 to review and moderate events uploaded by Events Promoters 12 and Membership Managers 13, including where uploaded or input via an interface by way of the Events Auto Population Module 25. They can note required updates against the events with notifications for the corresponding Events Promoters 12 and Membership Managers 13, and set the event's pending or publishable status.

Event Promoters 12 can in this way position their events directly in sight of Interested Individuals who have an explicit and direct interest in them, who are more likely to observe the information given their presence for achievable events information across their interests, and are more likely to observe them repeatedly as the events are positioned in this way on a lasting basis.

This contrasts with relying on the probability that interested individuals will seek event information actively and successfully for that type of event using other methods. It also removes the need for setting up proprietary publications, online presence or other media, or advertising one's events alongside other online information with a high element of chance in the advertisement's successful sight.

The Events Promoters 12 can also position associated commercial opportunities such as ticket sales alongside the events, accessible using the Actions Module 38.

### 3.5 Membership Groups Module

A Membership Groups Module 29 is accessible by the Membership Managers 13, using which they manage the membership groups of Interested Individuals 11 for the corresponding Membership event Categories and Cross-category Commodities. In one embodiment they may do this by way of the Interested Individual's 11 email address or a unique username.

They or associates will also act as per Events Promoters 12, using the Events Submission & Moderation Module 28 to introduce events and benefitting from the above considerations. Membership Managers 13 are thus able to provide events information directly to members of that membership group—with those members efficiently able to and likely to view it—without having to establish their own online presence and without exposing that information to non-members.

### 3.6 Advertisements Module

An Advertisements Module 30 is accessible and used by Advertisers 14 to assign advertisements with business rules to Categories, Cross-category Commodities and events, qualified where required by Locations, Venues and Timeframes, for those advertisements to be displayed alongside the corresponding events. Advertisements are stored in the Advertisements Module 30 and mapped against the Interests Framework Module 11.

They will be displayed with a frequency corresponding to, for example, the number of other advertisements also applying to given combinations.

Often currently, the frequency with which advertisements meets viewers' interests can be limited as only a single specification of interests has been made by the viewer, such as by a given piece of search engine syntax. This limitation results in an associated limitation to the cost effectiveness of advertisements.

In other cases currently, derivations of a user's interests are made from the complete breadth of their internet usage. This can mean either an intrusion into a user's unannounced interests (short of the user fully navigating cookie and access-control settings) or an element of misdirected advertising (with associated cost) where the internet usage may not correspond fully to a user's actual interests.

The richer specification of the Interested Individual's 11 interests here, available on an ongoing basis and having been captured effectively and efficiently, provides for more effective and relevant positioning of adverts according to individuals' interests, maintaining the anonymity of the user and privacy of their interests whilst driving an improved cost effectiveness of the advertisement effort.

### 3.7 Above Modules Administered by the EIP and Mapped within the Interests Framework

The Events Population Module 24, Events Auto Population Module 25, Manage 3rd Parties Module 26, Events Submission & Moderation Module 28 and Advertisements Module 30 are ultimately administrated by Events Information Providers 10 and mapped within the Interests Framework Module 20.

These modules are created at the outset. Further modules are provided, though they may be created and/or populated as the operation of the system gets underway and details of particular events are to be added to the system.

### 3.8 Personal Events Insertion Module

Each Interested Individual 11 can introduce and edit their Personal events using the Personal Events Insertion Module 32, assigning each event to a Personal event Category established within the Interests Framework Module 20, setting the event as one-off or recurrent as applicable and adding any Location and Timeframe Time Zone information required. The Personal event is established for and constrained to this Interested Individual 11, unless shared with other Interested Individuals 11. The possible kinds of Personal events are wide ranging but can be envisaged to include for example one-off events such as holidays or work events or recurrent events such as birthdays or anniversaries.

Currently Personal events in personal calendars typically can't benefit from being seen alongside the many Public events across one's breadth and levels of specificity of interests and the Membership events for one's applicable memberships. Where Public events are copied across into a personal calendar, typically it is as a point-in-time instance not benefiting from ongoing accuracy of the updated underlying event information, nor incorporating all applicable newly arising events without significant effort each time.

### 4. Query Output+Actions

### 4.1 Single-Demand Upcoming Events

The Interested Individual can demand in a single action an instantaneous and privacy-controlled consolidated set of upcoming events for their various interests, bringing them:
in one embodiment, all available forthcoming events for their interests, including those already presented to the Interested Individual 11 and flagged in the system as such, and newly arising events not yet presented to them
in one embodiment, only newly arising events for their interests, where newly available and not yet flagged as having been presented to them
in either case, further constrained by Location, Venues and/or Timeframe, where preferred by the Interested Individual 11.

They can do this at any point in time in a single action, for example with a single click, avoiding each time the full and essentially unmanageable search effort that would otherwise be necessary. The single demand can be one of various options, as expanded further below.

The Single Demand Upcoming Events Module, 36, reads:
the Events Population Module 24
and/or for Public Events, with or without Cross-category Commodity values being applicable:
   externally-interfaced data sources compatible for cross-referencing with one or more of the Category and Cross-category Commodity values: these may for example be data sources with the same Category values such as ‘Bank Holidays’, or where the internal Category or Cross-category Commodity value is mapped with a corresponding external name or identifier, mapped using the Events Auto Population Module 25
   and/or in one embodiment the internet more widely, with only syntax matching of Category and Cross-category Commodity parameters as opposed to direct matches or mapped matches.
      for the Interested Individual's 11 interests set in the Seamless Interests Setting Module 22 and provides the consolidated set of events immediately, comprising:
1. all Public events across their corresponding Category interests at high levels or increasingly detailed levels of interest specificity
2. all Personal events across their corresponding Category interests at high levels or at increasingly detailed levels of interest specificity, with no further access control action needed from the Interested Individual 11
3. all Membership events for their corresponding Category interests to which their access has been configured previously in the Membership Groups Module 29, with no further access control action needed
4. all events for their combined Cross-category Commodity interests selected in conjunction with specific Categories at high levels or increasingly detailed levels of interest specificity
5. all events for their Cross-category Commodity interests applying alone, i.e. for events for the Cross-category Commodities belonging to any or all Categories
6. and if selected by the Interested Individual 11, all individually preferred events.

As noted previously, as a key efficiency, the single earlier selection of an interest in a Category in the Seamless Interests Setting Module 22 covers without further effort the selection of an interest in all of its sub-Categories and therefore in the associated events.
In one implementation, this is made effective through the Seamless Interests Setting Module 22, setting all iterative levels of sub-Categories of a selected (sub-)Category as interests too
In another implementation this is made effective through the SDUEM 36, deriving at the time all iterative levels of sub-Categories of a selected (sub-)Category as interests too and including their events in the events provision.

The events are displayed if they are applicable to the given Interested Individual's 11 Geodomain, and according to any Geodomain-specific wording/syntax.

As selected by the Interested Individual 11, the events are also constrained to: a Location of interest, as set in the Location Preference sub-Module 22.1, including a preferred distance/radius around the location; Venues of interest to the user, as set in the Venue Preference sub-Module 22.2; a Timeframe of interest to the user, as set in the Timeframe Preference sub-Module 22.4. The event Timeframes are displayed as per the Interested Individual's preferred Time Zone approach, as set in the Time Zone Preference sub-Module 22.3.

Along with the event name/title, the information provided for each event will typically include the event's Category (primary Category and other Categories if it belongs to more than one) irrespective of whether it was a preferred interest; applicable Cross-category Commodities, qualified by any Context values; Timeframe—the date(s) and any specific timing, or broad Timeframe—with specific date(s) and timings displayed as per the Interested Individual's 11 preferred Time Zone approach; Location information with or without a map; Venue; details of further information sources where applicable; other linked resources where applicable, including for ticketing, travel arrangement and other commercial purposes.

In summary, as new events are added to the Events Population Module 24, these may be displayed when the Interested Individual 11 selects the display or events (and the query of their selected interests is run), encompassing both Categories and Cross-category Commodities and qualified by location, venue and or timeframe. Also, events may be updated regarding their various parameters and key information including timing. This too is efficiently reflected in the display provided to the Interested Individual 11 for any given combination of interests at any time.

### 4.2 Views, Pivoting, Sorting and Filtering

Referring to FIGS. 5A and 5B, the Interested Individual 11 can choose to generate the set of forthcoming events for their interests whenever they wish, without having to re-enter their interests and in a preferred format according to a currently set default preference or switching to another view and between views as and when required. Views may be for example:
a list view, allowing rows of events to be sorted by chosen criteria
a calendar view, with events displayed on the applicable days
thumbnail/card format, providing for example an image representing the event along with the event information
a plan format view, with for example Categories, sub-Categories and Cross-category Commodities displayed as a set of displayable and hideable rows, with days displayed as columns and the number of corresponding events shown in the intersection
a map format view, with events indicated in the locations in which they are taking place
a list view within an email, generated and received by email
other views, as can be envisaged by one skilled in the art.

For example a list view FIG. 5A (and 5B) may be generated, giving the date/time, the event details, Location, Category, applicable Cross-category Commodities, and other fields that may be relevant.

FIG. 5A includes example Category and Cross-category Commodity interest selection examples and associated example events matching them, as follows:
Selection 1—Birthdays (a Personal event Category): Bob's birthday event
Selection 2—Comedy festivals (a Public event Category): Melbourne International Comedy Festival
Selection 3—Organisation 1 events, a Membership event Category: Organisation 1 Summer Conference
Selection 4—England (Cross-category Commodity) under Cricket Team Trackers (Category, Team Tracker type): all events in which the England cricket team are involved, regardless of the Category
   note in FIG. 5A and further in 5B, the Interested Individual 11 has only needed to make a single ‘England’ selection, under the Cricket Team Trackers (Team Tracker type) Category
   as seen in 5B, they have not needed to select any of the Categories, such as Test Matches, One Day Internationals and so on
   with that single selection, this Interested Individual is presented all matches in which the England Cricket team are involved, across for example One Day Internationals, 5-day Test Matches, 20 Over Matches (‘T20’) and Other Internationals+Tour Matches
   with other interests, the Interested Individual 11 could instead have selected specific Categories of events, or Cross-category Commodities/teams only for specific Categories
   the team's Context per match, Home or Away is also displayed.

The views can be sorted where applicable on selection by the Interested Individual 11, by one or more of the criteria, and/or filtered by criteria including by a given Location and approach, by Venues or by Timeframe.

In one embodiment, where a Location of interest has been specified by the Interested Individual 11 or determined from for example the Interested Individual's 11 device's current location, all events corresponding to the selected Interests are presented, with those corresponding to the specified or determined Location and a preferred distance from it distinguished visually from the other presented events. This visual distinction may take the form of highlighting, marking with an icon, different colouring, or some other distinction.

### 4.3 Single Click/Single Internal Demand & Other Internal or External Triggering

The generation of events for the Interested Individual's 11 interests may be demanded by the Interested Individual 11 with for example a single click, without having to re-enter any selections or constraints. In this way, the Interested Individual 11 does not have to re-enter interest data, select or reselect the sources that should be searched. This contrasts significantly with the multiple or unachievable set of operations that would otherwise be required and can be carried out instantaneously at any time.

The single demand may take one of a number of simple forms, including:
a single click of a button, named for example ‘Show me my events’
simply by accessing the system—having previously set their interests—including by navigating to the URL of the application if on the internet
simply refreshing the view, or with the display updated automatically periodically or in response to some other action
triggered with the simple action of submitting one's event interests
triggered by a chronologically set automatic task, including with the events provided by delivery by a chronologically sequenced email
other forms can be envisaged by one skilled in the art.

Triggers from within or external to the system can with identification of the Interested Individual and, where applicable, with a relevant criterion (a), also trigger the display within the system or response to another system of the Interested Individual's 11 consolidated event set for their interests.

This trigger and criterion (a) may include, either separately or together:
a Location trigger—using for example a default radius—such as:
   the Interested Individual's 11 device's location having changed
   the Interested Individual 11 searching for directions to a given location in another system/application
a Venue trigger, such as:
   the Interested Individual 11 seeking a particular event at a particular Venue, on that Venue's or another related internet site
a Time Frame trigger, such as:
   the Interested Individual 11 searching for a hotel booking or carrying out other travel planning according to particular dates.

It will be realised that the request could also be initiated by a sequence of operations or demands.

### 4.4 External Query for Events According to the Interests Framework

Not related to a particular Interested Individual 11, an external system may query the Events Population Module 24 for events matching one or more of the following, or combinations thereof, and have the events returned accordingly: Categories; Category and Cross-category Commodity combinations, acting according to the Categories' Category Types; Cross-category Commodities; Locations; Venues; Timeframes. This may also entail constraint by Location and a specified or default radius, one or more Venues, Timeframe, according to a specified Time Zone approach where required.

### 4.5 Advertisements Display

Adverts stored with business rules in the Advertisements Module 30 and mapped to the Interests Framework Module 20 are displayed alongside events, depending on advertisements-display permissions from the Interested Individual 11, according to their preferred Categories and Cross-category Commodities and qualified where required by their preferred Locations, Venues and Timeframes.

Advertisements will be displayed with, for example, a frequency driven by the number of other advertisements also applying for given combinations.

This results in:
Interested Individuals 11—where agreed—being provided advertisements linked much more directly to their declared interests rather than according to derived, perhaps inaccurate and perhaps intrusive activity based rules
Interested Individuals 11 nevertheless maintaining their anonymity and the privacy of their interests, as the advertisements are mapped to those interests and not to them as individuals
Advertisers being able to direct their advertisements much more directly to individuals with declared associated interests targeted by the advertiser, driving an improved cost effectiveness of those advertisements.

### 4.6 Actions, Event-Level Actions and Views

Using the Events Actions Module 38, the Interested Individual 11 can carry out further planning supporting actions across the consolidated events set, including:
downloading the set of events together to electronic storage, computer-based calendars or tools
sending together for example by email
printing together
incorporating all or selected events together into a printable and/or printed calendar and these could be exported, or emailed or otherwise forwarded to others.

The Interested Individual 11 can also select an individual event view, with detailed information for the event. In the case of events information, individuals often want to be involved in the event in some way or act on that information rather than just know it. For individual events from multiple or individual event views the Interested Individual 11 can, again using the Actions Module 38, carry out further actions within the system or through cross-reference with other systems, including:
marking out as of particular interest individually, including for sight with other such events or for inclusion in the consolidated set for one's interests
storing ‘offline’ or in computer memory, such as on a phone
adding to other calendars operated for other reasons
setting reminders or notifications for the event through various media, at preferred timeframes before the event takes place
obtaining further information for the event from additional sources, including further location information and directions
getting travel information or access to associated travel services
obtaining broadcast information where applicable
seeing the timing of the event according to other Time Zones
purchasing tickets and associated products
recommending updates to the information where applicable
submitting photos for inclusion in the events information
seeing similar events by Category, Cross-category Commodity or other criteria, or combinations thereof
running queries on the Events Population Module 24 or interfaced external systems on those criteria
seeing advertisements associated with the event, Category, Cross-category or other criteria associated with the event
various social engagement actions as set out below.

### 4.7 Social Engagement Actions

Particularly useful in the field of events that people may attend or want to observe remotely, social engagement actions are also possible for the events, including:
sharing the event with others, internally or through external tools
inviting others to join them in their involvement in the event
commenting on or expressing an interest in the event or publishing one's involvement in the event to those following one's involvements
engaging with other Interested Individuals who share one or more of the same interests.

The capability of the system to gather an individual's interests practically across their many and varying levels of specificity of interests, and actively specified by the individual, provides the basis for Interested Individuals to connect to others by shared interests and shared combinations of interests. Algorithms can be established on the system to prompt potential connections based on shared Categories and Cross-category Commodity interests along with other criteria.

### 4.8 Demarcated Event Sets

As a second purpose of the SDUEM 36, other event views can be requested by and presented to an Interested Individual 11, either:
from direct selection within the Seamless Interests Setting Module 22 of a single Category, Cross-category Commodity, Location, Venue or Timeframe, or combination thereof
by direct selection of one of these from events views within the system or events views received from the system for example by email
through a search function within the SDUEM 36, with searching by simple syntax or by values for selected combinations of criteria
by direct selection of demarcated groupings, including:
   all events for specifically demarcated Categories, such as an ‘Editor's Pick’ Category grouping events selected by the Event Information Provider 10
   all events for Categories sharing a particular Category Nature
   all events for which the Interested Individual 11 has set a reminder
   all events to which the Interested Individual 11 has been invited
   all Personal events belonging to the Interested Individual 11
   all events saved offline within the system, such as on a phone
   all events that the Interested Individual 11 has marked out as being of a particular interest individually.

Where not relating to access-controlled Categories of events, these views can be accessed by Interested Individuals 11 that have not, or not yet, identified and authenticated themselves on the system.

### 4.9 Interest Sets Used on External Data Sets

Where sought by the Interested Individual 11, their interests set as specified in the Seamless Interests Setting Module 22 can also be exported to or provided by the Interested Individual 11 to compatible 3^{rd} party applications recognising the interest options, for use with those applications.

### 4.10 Interests Enhancing Search Engine Technologies

The Seamless Interests Setting Module 22 can be used to enhance search engine technologies:
the preferred individual Categories, preferred individual Cross-category Commodities, and preferred combinations of Categories and Cross-category Commodities according to the associated Category Types are read from the Seamless Interests Setting Module 22, as described above
an individual search engine search is run against each of these with ‘events’ related syntax appropriate for the given search engine, with the results sets returned combined to generate an overall events set for these interests, to the extent that the results sets are constrained to events information
this relies upon syntax matching, and so does not bring the same level of accuracy as direct selection of interests mapped in the Interests Framework Module.

Additionally, the currently preferred Location, Venue, date and or time, and Time Zone syntax can optionally be included in each of the individual searches, and therefore the compound search, nevertheless limited to the corresponding syntax matching.

1. A system for Event organisation, event interests capture and events display, comprising:
an events collection, containing events each event having a time value
a category structure, comprising categories and sub-categories
a plurality of cross-category commodities each comprising an interest relating to more than one category or sub-category
an interest selection display interface, by which means a user can rapidly and without duplication select and/or deselect, only necessary once or amending when desired
interests in one or more categories or sub-categories at various levels of specificity, and/or
interests in one or more cross-category commodities applicable to given categories or sub-categories, and/or
interests in one or more cross-category commodities applicable irrespective of categories or combinations thereof
and the selection is re-presented to the user in the selection interface display
the step of storing the selected interests
to read at any time the selected interests and formulate a corresponding query and carry out the query on the events collection to generate a corresponding set of newly arising events for those selected interests, including
events that match selected categories or sub-categories at various levels of specificity, and/or
events that match the intersections of selected categories or sub-categories with selected cross-category commodities, and/or
events that match selected cross-category commodities irrespective of category or sub-category
an events results display interface to immediately display newly arising forthcoming events for those selected interests.

2. A system for Event organisation, event interests capture and events display, comprising:
an events collection, containing events each event having a time value
a category structure, comprising categories and sub-categories, and/or
a plurality of cross-category commodities each comprising an interest relating to more than one category or sub-category
an interest selection display interface, by which means a user can rapidly and without duplication select and/or deselect, only necessary once or amending when desired
a plurality of interests in categories or sub-categories at various levels of specificity, and/or
interests in one or more cross-category commodities applicable to given categories or sub-categories, and/or
interests in one or more cross-category commodities applicable irrespective of categories or sub-categories, and/or
with differing access control requirements across the categories, sub-categories or cross-category commodities, and/or
a decision to include all individually-preferred events
where these options are displayed in a manner where no distinction is made between the displayed options
and the selection is re-presented to the user in the selection interface display
the step of storing the selected interests
to read at any time the selected interests and formulate a corresponding query and carry out the query on the events collection to generate a corresponding set of newly arising events for those selected interests, including
an events results display interface to immediately display newly arising forthcoming events for those selected interests, in a single display across the whole category and cross-category commodity structure.

3. A system for event organisation, event interests capture and events display, comprising:
two or more events collections, each containing events each event having a time value, the events collections having different access or privacy requirements
a category structure, comprising categories and sub-categories
an interest selection display interface, by which means a user can rapidly and without duplication select and/or deselect, only necessary once or amending when desired
a plurality of interests in categories or sub-categories at various levels of specificity, and/or
a plurality of interests in categories or sub-categories at various levels of specificity whose display to the user is controlled separately
where these options are displayed in a manner where no distinction is made between the displayed options
and the selection is re-presented to the user in the selection interface display
the step of storing the selected interests
to read at any time the selected interests and formulate a corresponding query and carry out the query on the events collection to generate a corresponding set of newly arising events for those selected interests and according to the privacy requirements, without further security control action by the user, including
an events results display interface to immediately display newly arising forthcoming events for those selected interests, in a single display across the whole category structure.

4. The system for Event organisation according to claim 1 wherein the events collection comprises a database.

5. The system for Event organisation according to claim 1 wherein Cross-category Commodities can be displayed as output information according to, and events results can be sorted, searched or filtered by, that Cross-category Commodity's context for the event.

6. The system for Event organisation according to claim 1 wherein Cross-category commodities have their own levels of specificity and hierarchy.

7. The system for Event organisation according to claim 1 wherein a single selection of a cross-category commodity determines, depending on both its positioning within the hierarchy beneath a category and that category's type:
whether the Cross-category interest applies either as a first case of all Categories or as a second case of only a specific one (or more)
the interest in events belonging to any and all Categories if the first case, and relating to this Cross-category Commodity
the interest specifically in the adjoining Category if the second case, and relating to this Cross-category Commodity.

8. The system for Event organisation according to claim 1 wherein the single-action selection of a Category or Sub-category results in selection of all of its descendant categories as well.

9. The system for Event organisation according to claim 1 wherein the system allows users to register with the system, but allows an unregistered user to carry out a search.

10. The system for Event organisation according to claim 1 wherein the events include a location characteristic and a preference for a given location and radius around that location of events can be selected to apply across events and the events results are constrained accordingly.

11. The system for Event organisation according to claim 1 wherein the events include a venues characteristic and a preference for given venues of events can be selected to apply to across events and the events results are constrained accordingly.

12. The system for Event organisation according to claim 1 wherein a preference for a given timeframe of events can be selected to apply to all events and the events results are constrained accordingly.

13. The system for Event organisation according to claim 1 wherein users are grouped into geodomains, and wherein the availability, ranking/ordering, naming and description of Categories and Cross-Category Commodities, and the availability and naming of Events is dependent on the geodomain of each user.

14. The system for Event organisation according to claim 1 wherein the events time values include a Time Zone characteristic and a preferred uniform Time Zone approach is applied across all events, being one of the following:
the local time zone of each event, allowing for daylight saving differences over the year where required
the time zone the user is currently in where known, allowing for daylight saving differences over the year where required
as per a specified preferred time zone, allowing for daylight saving differences over the year where required.

15. The system for Event organisation according to claim 1 wherein the events results can be represented into each of multiple display structures or formats of various use to the individual, sorted or filtered according to one or more criteria.

16. The system for Event organisation according to claim 1 wherein the events results set as a whole may be exported for use in other applications, for example:
downloading the set of events together to electronic storage, computer-based calendars or tools
sending together for example by email
printing together for subsequent activity from there
incorporating all or selected items together into a printable/ed calendar.

17. The system for Event organisation according to claim 1 wherein an individual event view is obtainable with event-specific information, and planning-supporting and social engagement actions can be carried out for the individual event, chosen from the following;
marking out as of particular individual interest including for sight with other such events or inclusion in the consolidated set for one's interests
storing ‘offline’ or in computer memory, such as on a phone
adding to other calendars operated for other reasons
setting reminders or notifications for the event through various media, at preferred timeframes before the event takes place
obtaining further information for the event from additional sources including further location information and directions
getting travel information or access to associated travel services
obtaining broadcast information where applicable
seeing the timing of the event according to other Time Zones
purchasing tickets and associated products
recommending updates to the information where applicable
submitting photos for inclusion in the events information
seeing similar events by Category, Cross-category Commodity or other criteria, or combinations thereof
running queries on the Events Population Module or interfaced external systems on those criteria
seeing advertisements associated with the event, Category, Cross-category or other criteria for the Event
sharing the event with others, internally or through external tools
inviting others to join them in their involvement in the event
commenting on or expressing an interest in the event or publishing one's involvement in the event to those following one's involvements
engaging with other Interested Individuals who share one or a combination of the same interests.

18. The system for Event organisation according to claim 1 wherein a other results sets can be obtained from the events collection according to, in conjunction with or separately from the user's selected interests, the results sets being generated by performing a step chosen from the following:
by direct selection within the Seamless Interests Setting Module of a single Category, Cross-category Commodity, Location, Venue or Timeframe or combination thereof
by direct selection of one of the same, from Events views within the system or received from the system for example by email
through a search function within the Single Demand Upcoming Events Module, by simple syntax or selected combinations of criteria
by direct selection of Categories grouping Events as demarcated separately by the Event Information Provider
by selection of events that have been demarcated,
the query which returns the results sets including at least one of the following:
all Events that are Public events/Personal events/Membership events/all events for a Cross-category Commodity in conjunction with a specific Category(ies)/all events for a Cross-category Commodity irrespective of Category
all Events for Categories sharing a particular Category Nature
all Events for which the user has set a reminder
all Events to which the user has been invited
all Personal Events belonging to the user
all Events saved offline within the system, such as on a mobile phone
all Events that the user has marked out as being of a particular interest individually
all Events with assessed levels of certainty of taking place.

19. The system for Event organisation according to claim 1 wherein the the step of selecting and/or deselecting Categories and/or Cross-category Commodities, and the display of the newly arising forthcoming events for those selected Categories and/or Cross-category Commodities is in response to a single user action.

20. The system for Event organisation according to claim 1 wherein the events have one or more characteristics and the events can be returned according to one or more of those characteristics and that characteristic(s) is provided by an external application, with the events returned within the system or returning the events results to that external application.

21. The system for Event organisation according to claim 1 wherein the interests selected are used as search parameters for a search engine, augmenting the capability of the Search Engine.

22. The system for Event organisation according to claim 1 wherein users can connect socially with other users with like interests or combinations of interests following according to their interests selections.

23. The system for Event organisation according to claim 1 wherein business rules are defined and applied to the actively-specified user interests and advertisements published to the user according to those interests combinations and rules.

24. The system for Event organisation according to claim 1 wherein event information providers, 3rd party event information providers and membership administrator event information providers and advertisers are enabled to provide events information, commercial opportunities and adverts directly to individuals with directly-specified interest in the given events.

25. The system for Event organisation according to claim 1 wherein the option exists to also or only display up to date version of events previously displayed to the user.

26. The system for Event organisation according to claim 3 wherein events personal to the user are inserted or automatically added into the system.

27. The system for Event organisation according to claim 3 wherein membership event categories across one or more memberships are presented to the user for selection, where the accessibility of these categories to the user has been pre-determined.

28. The system for Event organisation according to claim wherein membership group managers and membership event promoters are enabled to limit access to the corresponding events to members of the given membership group.

29. The system for Event organisation according to claim 3 wherein selection of a membership controlled Category is carried out by the user with a single action, with no further access steps required

30. The system for Event organisation according to claim 1 wherein the sub-sets of Categories, Sub-Categories and Cross-category Commodities are expandable and collapsible to see more or less as required

31. The system for Event organisation according to claim 1 wherein the sub-sets of Categories, Sub-Categories and Cross-category Commodities are displayed above and under each other and/or indented

32. The system for Event organisation according to claim 1 wherein the events belonging to a given Category or Sub-Category or Cross-category Commodity or combination thereof are displayed when selected, including so as to inform the interest selection decision.
